(19) United States
(12) Patent Application Publication
(10) Pub. No.: US 2024/0222904 A1
(43) Pub. Date: Jul. 4, 2024

(54) PLUG RECEPTACLE

(71) Applicant: HARTING ELECTRONICS GMBH, Espelkamp (DE)

(72) Inventor: Luca BALTRUSCHAT, Minden (DE)

(21) Appl. No.: 18/293,280

(22) PCT Filed: Jul. 15, 2022
(86) PCT No.: PCT/DE2022/100508

§ 371 Date: Jan. 29, 2024

(30) Foreign Application Priority Data
Jul. 30, 2021 (DE) 10 2021 119 868.2

(51) Int. Cl. H01R 13/622; H01R 13/627; H01R 43/18

(52) U.S. Cl. CPC H01R 13/622; H01R 13/627; H01R 43/18

(57) ABSTRACT

A plug receptacle is provided for a connector socket for recessed installation in a plastic wall and suitable for receiving and screwing to a screw connector to be connected to the connector socket, and also suitable for latching of a latching connector to be connected to the connector socket, the plug receptacle including an internal thread portion having an internal thread for screw connection to an external thread of the screw connector; and an all-round or interrupted inwardly directed latching catch or lug arranged at the plugging end of the internal thread for latching with the latching connector, the plug receptacle for installation in the plastic wall having a self-tapping external thread and being made of metal. A connector socket, a circular connector system, a device housing, and a method for producing a device housing having a plug receptacle are also provided.

### BACKGROUND

### Technical Field

The present disclosure relates to a plug receptacle for a connector socket, and also a connector socket, which has a plug receptacle and, in addition, a contact carrier and at least one plug contact arranged in the contact carrier.

The disclosure also relates to a circular connector system, a device housing having at least one plug receptacle, and a method for producing a device housing having a plug receptacle.

Plug receptacles of the present disclosure are needed to receive a circular connector and to lock it against being pulled out unintentionally.

A device housing of embodiments of the present disclosure may be part of an electric device. Such an electric device may serve, for example, to receive analog and/or digital electrical signals and to process them and/or transform them and/or forward them. The electric device may be a connection box for a data network, such as a so-called “I/O link module”, which is also referred to as an “I/O connection box”. Such a connection box may serve as a network interface for components connected thereto and, to this end, may provide a plurality of such plug sockets and/or connectors in order to link components connected thereto to a data network, for example. Via its connectors, the device may link field devices, such as sensors and actuators, to a control device, for example, via the data network.

### Description of the Related Art

Printed document WO 2020/119854 A1 discloses a circular connector system, having a connector socket with screw and latching locking and a circular connector to be plugged into said connector socket. This system therefore provides both a screw connection and push-pull latching for locking the plug connection. To this end, it is proposed, amongst other things, that the outwardly directed latching hooks of the circular connector be arranged between its mating region and its contact carrier portion. The connector socket has an inwardly directed, encircling or interrupted latching lug on the mating side of its internal thread portion. Therefore, the latching arms of the circular connector to be plugged in do not need to reach through the internal thread portion of the connector socket for locking purposes. The latching arms may therefore be of particularly short and strong design and the internal thread of the connector socket may be of continuous, i.e., non-segmented, design. The holding force of the respective locking mechanism is consequently high and the construction of the circular connector is comparatively simple. The latching arms of the circular connector may, for example, be integrally formed on the plastic insulating body of the circular connector during the production of this latter, and in one piece therewith.

When manufacturing device housings, such as when manufacturing connection boxes, it has proven disadvantageous that the latching lugs of the connector sockets, which are formed by an undercut on the mating side, may only be realized with considerable effort by the injection-molding technique used for this purpose.

Moreover, it has proven further disadvantageous in this prior art, e.g., in tests and simulations, that the stability of the latching lug of the connector socket in some of these designs is not always adequate and/or the dimensions of the latching lug are undesirably large, i.e., they take up valuable installation space within the connector socket.

The German Patent and Trademark Office has searched the following prior art in the priority application relating to the present application:

DE 10 2020 103 896 A1, DE 10 2020 112 793 A1, U.S. Pat. No. 7,491,081 B2 and WO 2020/119854 A1.

### BRIEF SUMMARY

Embodiments of the disclosure provide a plug receptacle for a connector socket which is easy to manufacture, wherein the plug receptacle enables both screw locking and latching locking and wherein its design simplifies the production of a device housing using an injection molding technique.

A plug receptacle for a connector socket is suitable for recessed installation in a plastic wall, i.e., a wall which is made of a plastic material.

The concept of “recessed installation” is understood here and below to mean that, in the mounted state, the plug receptacle does not project out of the plastic wall on the mating side. This recessed installation has the advantage, amongst other things, of saving on space both in the mating direction and perpendicularly thereto, i.e., in the plane of the housing wall.

The plastic wall may be part of a device housing. The plastic wall may be an entire plastic wall of the device housing or at least a section of such a housing wall. The entire device housing may be made of plastic. However, the housing wall must be made of plastic at least in the region in which the plug receptacle is installed, i.e., it must have the plastic wall in this region, for example. The said device housing may therefore be made at least partly, such as mostly and entirely of plastic and may therefore be entirely or partly produced in an injection molding process. The device housing may be part of an electric device, for example, a connection box.

The plastic wall may have an initially threadless installation opening with a cylindrical external contour for the installation of the plug receptacle, wherein the installation opening is surrounded by the plastic material of the plastic wall.

The plug receptacle may be screwed into the installation opening of the plastic wall by its self-tapping external thread and may thereby cut a mating thread in the installation opening, i.e., in the plastic material surrounding the installation opening. This is also advantageous since compatibility problems, for instance caused by different threads, may be avoided.

The plug receptacle is, on the one hand, suitable for receiving a screw connector to be connected to the connector socket and for the screw connection thereof, which the screw connector is notable for having an external thread for this purpose.

On the other hand, the plug receptacle is also suitable for the latching of a latching connector to be connected to the connector socket, which the latching connector may have a plurality of outwardly directed latching hooks or latches for this purpose.

The plug receptacle may be summarized as including: an internal thread portion having an internal thread for screw connection to the screw connector and to the external thread of the said screw connector; and an encircling or interrupted, inwardly directed latching lug, arranged on the mating side of the internal thread portion, for latching with the latching connector, such as with the outwardly directed latching hooks or latches of the latching connector.

In some embodiments, the plug receptacle may have a self-tapping external thread for installation in the housing wall of the device housing and the plug receptacle may be made of metal.

In some embodiments, the manufacture of a device housing is simplified due to the plug receptacle.

In some embodiments, the latching lug is particularly stable, due to the metallic material from which it is made, and thus, withstands particularly high tensile forces.

At the same time, in some embodiments the plug receptacle, and the latching lug thereof, is of compact design.

The production of the device housing is simplified considerably through the use of the plug receptacle, since, during its production, an undercut does not need to be formed in the plastic material, such as using an injection molding process, to form the latching lug in the plastic material. In some embodiments, an undercut of this type can specifically only be realized with great difficulty using the customary, and otherwise very advantageous, injection molding process.

In some embodiments, due to its metallic material, the latching lug, such as in the mating direction and/or perpendicularly thereto, may be of narrow design and yet still has a high level of stability. This saves on valuable installation space within the plug receptacle, and therefore also in the connector socket of which it is part, and enables the desired compact design. As a result, the latching hooks of the latching connector to be plugged therein may have particularly small dimensions.

A significant advantage consists in that the plug receptacle is also suitable for the customary screw connection of a screw connector, which, to this end, has an external thread corresponding to the internal thread of the plug receptacle, and also has a particularly high level of stability in terms of this screw connection owing to its metallic material.

Some embodiments provide the advantage that the plug receptacle can be mounted in the plastic wall of the device housing with little effort by its self-tapping external thread—and specifically screwed into the installation opening of the plastic wall in a self-tapping manner—wherein the self-tapping thread of the plug receptacle cuts a mating thread into the plastic material of the plastic wall which surrounds the installation opening.

It is advantageous here that the metal from which the plug receptacle is made is harder and more resistant than the plastic material of the plastic wall. As a result, not only is the holding force of the latching lug increased, but the production of such a device housing equipped with installation sockets and, in other words, the mounting of such plug receptacles in the plastic wall of the device housing, is also made significantly easier. Due to the use of the self-tapping thread, there is also no need for a coupling ring for the screw connection of a wall bushing with an external thread portion projecting from the device housing on the mating side. As a result, the plug receptacle may be installed in a fully recessed manner in the plastic wall and does not have to project out the housing wall with an external thread portion on the mating side (as is otherwise customary in the prior art) for screw connection via a coupling ring that is therefore advantageously not needed when using the said plug receptacle. This advantageously saves on space both in the mating direction and perpendicularly thereto and dispenses with a part which is losable.

In some embodiments, a further advantage of the recessed installation of the plug receptacle is also revealed in customary practical applications of the above-mentioned connection boxes, which are also known as so-called “I/O boxes” to a person skilled in the art of automation. In this technical field, it has long been customary to characterize and identify installation sockets according to their respective function (inputs, outputs, looped-through signals, etc.), regardless of whether or not they are installed in a recessed manner. For simple screw connectors, this was hitherto unproblematic. In association with modern latching connectors, such as so-called “push-pull connectors”, i.e., latching connectors which can be released by pulling a release sleeve, the need for recessed installation has led to new requirements, which are based on the additional demand for backwards compatibility with the previous screw locking mechanisms and are advantageously met through the above-mentioned advantages of the plug receptacle.

Therefore, in this technical field, a plug receptacle/connector socket which is installed in this type of recessed manner may offer convenient use of a so-called “inverse push-pull” latching connector, which is also referred to among experts as “push-pull connector with internal locking”. Such an inverse push-pull connector engages, and latches, in the plug receptacle/connector socket from the inside by its latching hook, wherein the latching hooks of the latching plug are customarily directed outwards. The push-pull latching connector has a release sleeve. When pulled, the release sleeve may bend latching arms—which belong to the latching connector and have latching hooks integrally formed thereon—inwards in order to release the latching hooks from the respective mating latching element, in the present case from the latching lug, and thereby release the plug connection.

In some advantageous embodiments, owing to its metallic material, the plug receptacle has a shielding effect against external electrical and/or magnetic fields. In some embodiments, it shields the plug contacts which are or will be arranged therein from external fields, even if the device housing in which it is installed is made at least partly of plastic, as already mentioned. This shielding effect may relate both to socket contacts and to pin contacts which are to be plugged therein. This is advantageous since, as a result, the device housing, which can also be easily and cost-effectively produced in the injection molding process and can be very flexibly adapted in terms of its shape to the requirements of the particular application, and, for example, connection boxes, which naturally have very many plug connections, may have particularly good shielding, enhanced in their particularly sensitive mating regions, to prevent mutual crosstalk and to protect against electrical and/or magnetic external fields.

In an advantageous embodiment, the plug receptacle has a substantially hollow cylindrical basic shape. This is advantageous since its basic shape is thus adapted to the inevitably circular shape of its internal and external thread in an expedient and material-saving manner.

The plug receptacle may advantageously have a continuous, substantially cylindrical, cavity as its receiving region. The internal thread may, be arranged internally on an internal thread portion of the receiving region, which creates a slight narrowing of the cavity. Although the receiving region has a narrowing in this portion, the plug receptacle also maintains its substantially hollow cylindrical basic shape in this internal thread portion. The concept of “substantially hollow cylindrical” therefore includes, amongst other things, a hollow cylindrical base body with the external self-tapping thread, the internal screw thread, such as in the narrowing internal thread portion, the mating-side latching lug and, also the mating-side conical top piece and, at the opposite end, also the encircling chamfer.

In some embodiments, the internal thread may be a metric thread and, particularly, an M12 thread, which is compatible with conventional M12 screw connectors. It goes without saying, however, that other thread sizes are also possible.

In an advantageous embodiment, the plug receptacle is a turned part. This means that the plug receptacle is produced in a turning process, such as a CNC (Computerized Numerical Control) turning process. The CMC process has the advantage that details such as external and internal radius, length and thread depth of the self-tapping external thread and of the internal thread provided for the screw connection of the screw connector can be easily adapted to respective requirements of the device design through the programming of a process computer and the plug receptacles may be produced in an automated and cost-effective manner, even in small batches. The undercut of the plug receptacle, which forms the said latching lug, can be produced more easily in the turning process than in the injection molding process.

In an advantageous embodiment, the plug receptacle has, on a mating-side end portion of the plug receptacle, an encircling top piece which widens conically to the mating-side end of the plug receptacle, at least in terms of its external contour. This serves to close the thread, which is or will be cut in the plastic wall by the receptacle, and is suitable for terminating flush with the plastic wall at a mating-side end face of the plug receptacle, whereby the plug receptacle can be installed in a recessed manner in the housing wall.

At its end opposite the mating side, the plug receptacle may have an encircling external chamfer, i.e., an encircling external bevel, which has a self-centering effect during the insertion of the plug receptacle into the installation opening of the plastic wall since the plug receptacle centers itself during its installation in the installation opening. This additionally increases the advantage of the simplified device production.

In some embodiments, the plug receptacle may be of substantially hollow cylindrical design.

As mentioned above, in a further embodiment, the plug receptacle may be a turned part.

The metallic plug receptacle may be made of a copper alloy and/or of an aluminum alloy, such as of brass.

The plug receptacle may be formed in one piece.

A connector socket has both the plug receptacle and in some embodiments, substantially cylindrical, contact carrier arranged therein, with at least one plug contact arranged in the contact carrier. The contact carrier may project into the plug receptacle, specifically into the cavity of the plug receptacle.

In some embodiments, the contact carrier may be arranged in the plug receptacle in a “floating” manner, and therefore project into the plug receptacle without being directly fastened to the plug receptacle. This has the advantage that the construction of the device/device housing, irrespective of design-related manufacturing tolerances of its components, may take place without resultant mechanical stresses and is therefore further simplified. The contact carrier may be a separate part.

In another embodiment, the contact carrier may be formed in one piece with the plastic wall, for example as a single, common injection molded part.

A circular connector system has the connector socket and a circular connector as a mating connector.

In this case, the circular connector may be either a screw connector, which has an external thread with which it can be screwed into the internal thread of the plug receptacle, or a latching connector, which has a plurality of outwardly directed latching hooks, with which it can be latched on the latching lug of the plug receptacle from the inside.

A device housing has at least one plastic wall and at least the plug receptacle installed in the plastic wall, wherein the at least one plug receptacle is screwed into at least one cylindrical installation opening of the plastic wall by means of its self-tapping external thread.

The plug receptacle here may be installed in a recessed manner in the plastic wall.

A method for producing a device housing with at least one such plug receptacle may be summarized as including the following steps: the device housing is formed using an injection molding process, with at least one plastic wall made of a plastic material, wherein at least one installation opening with a cylindrical external contour is integrally formed in the plastic wall; and in a second step, the at least one plug receptacle is screwed into the at least one installation opening by a self-tapping external thread belonging to the plug receptacle, wherein the external thread of the plug receptacle cuts a mating thread into the plastic material of the plastic wall which surrounds the installation opening.

In some embodiments, in the second step of the method, the plug receptacle may be screwed so deeply into the plastic wall that it is installed in a recessed manner therein.

### BRIEF DESCRIPTION OF THE SEVERAL VIEWS OF THE DRAWINGS

An embodiment of the disclosure is illustrated in the drawings and will be explained in more detail below.

FIG. 1a shows a substantially hollow cylindrical plug receptacle having a self-tapping external thread in a 3D illustration.

FIG. 1b shows a cross-sectional illustration of a connector socket, which has the plug receptacle screwed into a plastic wall, a contact carrier and plug contacts.

The figures may contain partially simplified, schematic illustrations. Identical reference signs are sometimes used for similar, but possibly not identical, elements. Different views of similar elements may be drawn to different scales.

### DETAILED DESCRIPTION

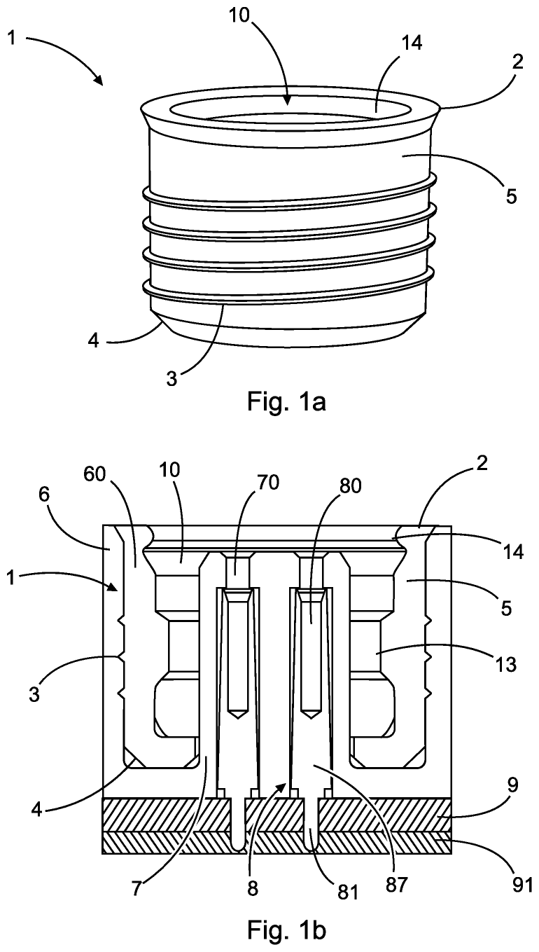

FIG. 1a shows a substantially hollow cylindrical plug receptacle 1, which therefore has a substantially hollow cylindrical base body 5 having a self-tapping external thread 3. At its mating-side end (illustrated at the top in the drawing), the plug receptacle 1 has an encircling top piece 2 on a mating-side end portion, which top piece widens conically to the mating-side end, at least in terms of its external contour. A slightly funnel-shaped internal contour (not shown in more detail) with an adjoining undercut, which forms an encircling latching lug 14, can furthermore be seen at the mating-side end. This encircling latching lug 14 serves for the latching of a latching connector (not shown), which is to be inserted on the mating side (i.e., from above in the drawing) and may have, for example, concentrically outwardly directed latching lugs, which engage in the latching lug 14 in from the inside in the latched state.

At its end opposite the mating side (which end is illustrated at the bottom in the drawing), the substantially hollow cylindrical plug receptacle 1 has an encircling external chamfer 4 for self-centering when it is screwed into an installation opening 60 of a plastic wall 6 (demonstrated below), e.g., the plastic wall 6 of a device housing.

As can clearly be seen in FIG. 1b, the plug receptacle 1 has a continuous cavity 10 as a receiving region. Within this cavity 10, which is of substantially cylindrical design, the plug receptacle 1 has an internal thread portion 13 which creates a narrowing of the cavity 10. The internal thread portion 13 is arranged on the connection side of the latching lug 14, i.e., below the latching lug in the drawing. In other words, the latching lug 14 is arranged on the mating side of the internal thread portion 13, i.e., above the internal thread portion in the drawing. The internal thread portion 13 has an internal thread (not illustrated in the drawing) for screwing in a screw connector (likewise not shown) on the mating side, which screw connector is to be inserted on the mating side (i.e., from above in the drawing). By way of example, but without being restrictive, the internal thread may be a metric thread such as an M12 thread, so that a matching, standardized metric screw connector, such as an M12 screw connector, can be plugged into the plug receptacle 1 and screw-connected to its internal thread.

The plug receptacle 1 is therefore suitable both for receiving and locking a latching connector and for receiving and locking a screw connector.

The self-tapping external thread 3 of the plug receptacle 1 serves for the installation of the plug receptacle 1 in the above-mentioned installation opening 60 of the plastic wall 6. To this end, the plug receptacle 1 is made of metal, for example of brass, and may be manufactured in a turning process. During the above-mentioned installation, the self-tapping external thread 3 of the plug receptacle 1 cuts a mating thread into the installation opening 60, i.e., in the plastic material 6 of the plastic wall 6 which surrounds the installation opening 60.

In the example shown here, the plastic wall 6 is formed in one piece with a contact carrier 7, wherein the contact carrier 7 projects into the cavity 10 of the plug receptacle 1. By way of example, the plastic wall 6 may be produced together with the contact carrier 7 as an injection molded part in a common injection molding process. This contact carrier 7 has a plurality of through-openings as contact chambers 70 in which a plug contact 8 is received in each case. Each plug contact 8 has a mating region 80 and a connection region 81 and also a holding portion 87 arranged between them, which holding portion holds the plug contact in the contact carrier 7. The plug contacts 8 illustrated here are socket contacts, since their mating region 80 is of socket-shaped design. On the connection side, i.e., illustrated at the bottom in the drawing, its pin-shaped connection region 81 projects through contact openings of a printed circuit board 9 and is electrically conductively rear-connected, e.g., soldered, to a trace 91 located there.

Even where combinations of different aspects of features of the disclosure are shown in the figures in each case, it is clear to a person skilled in the art—unless indicated otherwise—that the combinations shown and discussed are not the only possible combinations. In particular, mutually corresponding units or feature complexes from different exemplary embodiments may be interchanged with each other. In other words, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A plug receptacle for a connector socket for recessed installation in a plastic wall configured to receive a screw connector to be connected to the connector socket and for the screw-connection thereof, and also configured for the latching of a latching connector to be connected to the connector socket, the plug receptacle comprising:
an internal thread portion having an internal thread for screw connection to an external thread of the screw connector;
an encircling or interrupted, inwardly directed latching lug arranged on a mating side of the internal thread portion of the plug receptacle for latching with the latching connector; and
a self-tapping external thread for installation in the plastic wall, and
wherein the plug receptacle is made of metal.

2. The plug receptacle as claimed in claim 1, wherein the plug receptacle is of substantially hollow cylindrical design.

3. The plug receptacle as claimed in claim 1, wherein the plug receptacle is a turned part.

4. The plug receptacle as claimed in claim 1, wherein the plug receptacle is formed in one piece and is made of brass.

5. The plug receptacle as claimed in claim 1, wherein the plug receptacle has, on a mating-side end portion, an encircling top piece which widens conically to the mating-side end of the plug receptacle.

6. The plug receptacle as claimed claim 1, wherein the plug receptacle has, at an end opposite the mating side, an encircling external chamfer for self-centering.

7. A connector socket, comprising:
a plug receptacle as claimed in claim 1; and
a contact carrier; and
at least one plug contact arranged in the contact carrier,
wherein the contact carrier projects into the plug receptacle.

8. The connector socket as claimed in claim 7, wherein the contact carrier is formed in one piece with a plastic wall, wherein the plastic wall has an installation opening into which the plug receptacle is screwed via the self-tapping external thread of the connector socket.

9. A circular connector system, comprising:
a connector socket as claimed in claim 7; and
a circular connector serving as either the screw connector or the latching connector.

10. A device housing, comprising:
at least one plastic wall; and
at least one plug receptacle as claimed in claim 1, which is installed in the plastic wall, wherein the at least one plug receptacle is screwed into at least one installation opening of the plastic wall via the self-tapping external thread of the at least one plug receptacle.

11. The device housing as claimed in claim 10, wherein the at least one plug receptacle is installed in a recessed manner in the plastic wall.

12. A method for producing a device housing having at least one plug receptacle made of metal, the method comprising:
forming a device housing using an injection molding process, with at least one plastic wall made of a plastic material, wherein at least one installation opening with a cylindrical external contour is integrally formed in the plastic wall; and
screwing the at least one plug receptacle into the at least one installation opening via a self-tapping external thread of the plug receptacle, wherein the external thread of the plug receptacle cuts a mating thread into the plastic material of the plastic wall which surrounds the installation opening, and wherein the at least one plug receptacle further includes an internal thread portion having an internal thread for screw connection to a screw connector, and an encircling or interrupted, inwardly directed latching lug arranged on a mating side of the internal thread portion for latching with a latching connector.

13. The method as claimed in claim 12, wherein the screwing of the at least one plug receptacle into the at least one installation opening includes screwing the plug receptacle so deeply into the plastic wall that the plug receptacle is installed in a recessed manner in the plastic wall.

14. The circular connector system as claimed in claim 9, wherein the circular connector is the screw connector, which has the external thread with which the screw connector can be screwed into the internal thread of the plug receptacle.

15. The circular connector system as claimed in claim 9, wherein the circular connector is the latching connector, which has a plurality of outwardly directed latching hooks, with which the latching connector can be latched on the latching lug of the plug receptacle from an inside of the plug receptacle.
